(19) United States
(12) Patent Application Publication
(10) Pub. No.: US 2009/0323881 A1
(43) Pub. Date: Dec. 31, 2009

(54) Reactor geometry and dry confinement for a nuclear reactor enabling the racquetball effect of neutron conservation dry confinement to be supported by the four-factor and six-factor formula

(76) Inventor: Hector A. Dauvergne, San Leandro, CA (US)

Correspondence Address: DUANE MORRIS LLP, Suite 700, 1667 K Street, N.W., Washington, DC, 20006, US

(21) Appl. No.: 11/723,743

(22) Filed: Mar. 21, 2007

Related U.S. Application Data
(63) Continuation of application No. 10/786,530, filed on Feb. 24, 2004, now abandoned.
(60) Provisional application No. 60/450,506, filed on Feb. 25, 2003.
(60) Provisional application No. 60/450,384, filed on Feb. 25, 2003.

(51) Int. Cl. G21G 1/06; G21C 19/19

(52) U.S. Cl. 376/173; 376/267

(57) ABSTRACT

A nuclear-powered plant of a portable type with a confinement section where the reaction takes place in a core having a reactive thorium/uranium-233 composition, and where an external neutron source is used as a modulated neutron multiplier for the reactor core output. The core is housed in a containment structure that radiates thermal energy captured in a multiple-paths heat exchanger. The exchanger heat energy output is put to use in a conventional gas-to-water heat exchanger to produce commercial quality steam.

### RELATED APPLICATION DATA

The present application claims priority under 35 U.S.C. § 119 to U.S. Provisional Application Ser. No. 60/450,506 (Attorney Docket No. DAUVP001P), entitled “DRY CONFINEMENT FOR A NUCLEAR REACTOR WHERE THE “RACQUETBALL” EFFECT OF NEUTRON CONSERVATION DRY CONFINEMENT IS SUPPORTED BY THE FOUR-FACTOR FORMULA & DBI'S SIX-FACTOR FORMULA”, naming Hector A. Dauvergne as inventor, and filed Feb. 25, 2003, the entirety of which is incorporated herein by reference in its entirety for all purposes.

The present application claims priority under 35 U.S.C. § 119 to U.S. Provisional Application Ser. No. 60/450,384 (Attorney Docket No. DAUVP002P), entitled “A NEW GEOMETRY FOR A NUCLEAR POWER PLANT MOUNTED IN A TRAILER”, naming Hector A. Dauvergne as inventor, and filed Feb. 25, 2003, the entirety of which is incorporated herein by reference in its entirety for all purposes.

### FIELD OF THE INVENTION

The present invention relates to nuclear reactors, and more particularly, relates to portable nuclear-powered plants having confinement sections where a reaction takes place in a core having a reactive thorium/uranium-233 composition, and where an external neutron source is used as a modulated neutron multiplier for the reactor core output.

### BACKGROUND OF THE INVENTION

The nuclear power industry was essentially born in the 1950s with great promise as an energy source that would solve all future energy problems. Over the years, however, the U.S. nuclear industry has attempted to push ahead with vast, costly projects that carry with them an array of environmental, safety, and health risks. These costs and risks have stunted its growth. Indeed, the industry has come to a virtual standstill until 2003. Now with new construction in sight, if again waste is ignored, the associated risks will have resulted in political opposition and public fears that will tend to block not only plant expansion, but development of new forms of nuclear power as well.

In the 1970s, dreams of energy surpluses based on nuclear power soon turned into shortages, but the energy shortages of the period were followed in the 1980s by a glut that clouded the energy issue. According to many informed sources then, the U.S. would run low on electric generating capacity in the 1990s, a prediction that came to pass. John O. Sillin, Management Analysis Co., San Diego, Calif., Edison Electric Institute and United States Department of Energy (DOE) in “The Horn Blows at Midnight”. ELECTRICAL WORLD MAGAZINE (1990). Added to this problem is the depletion of the petroleum reserves needed to fuel power plants and a growing vehicle fleet. Currently, the U.S. imports a large percent of its petroleum from the Middle East. Additionally, alternative energy technologies—such as solar, wind, and geothermal—are losing governmental support. Indeed, the U.S. appears to be heading toward another energy crisis due to governmental policies, public fears of nuclear power, utility company shortsightedness, and corporate lack of incentives to either use alternative energy technologies or conserve energy.

On top of this assortment of energy problems, the U.S. is confronted with environmental matters when using any sort of energy-generating method, whether it be conventional (such as a coal-fired plant) or an alternative (like solar). Environmental concerns range over a wide array of atmospheric pollution impacts. Conventional nuclear power has its own set of drawbacks. Specifically, nuclear reactors generate radioactive wastes that remain in diminishing intensity for several centuries. These wastes require special handing, transportation, and storage. No state within the U.S. has been willing to become the national repository for nuclear refuse. This is a highly political, sensitive matter, and each state is grappling with its own methods of handling radioactive waste. Because of waste storage concern, high costs, and inherent health risks, it appears that conventional nuclear energy-generating means are being rejected. Moreover, there is fear of a meltdown that could release radioactivity, and concern that materials for nuclear weapons could be generated. These fears have continually plagued the industry, and since the 1990s it has appeared doubtful that conventional nuclear power generation will be allowed to grow as a means to meet energy deficiencies. In fact, there is a grassroots movement underway to shut down some of the existing nuclear power plants because of these concerns.

Since all conventional energy-generating sources present grave hazards to public safety, health, and psychological well being, U.S. citizens are demanding a clean, safe, and domestically-produced energy source. In an attempt to answer this demand, the U.S. government intended to require all automobile manufacturers to provide alternatively-fueled automobiles by the beginning of 2000. Since the most viable sources of alternative fuel are hydrogen and electricity, this demand cannot be fully enforced for the simple reason that both hydrogen and electricity are not energy sources but rather energy carriers that need a source of energy to start. Nuclear energy has not been promoted as an alternative because the perceived risks have been amplified by political and environmentalist pressure. Correspondingly, a search is being made to find energy-producing systems that either drastically reduce or eliminate the dangers of known alternative energy sources, real or perceived.

The search for clean, safe forms of energy generation has taken many paths. Fusion, for example, has the promise of being a clean, cheap, and virtually limitless source of energy. Briefly, nuclear fusion is the fusion of lightweight atomic nuclei, as of deuterium or tritium, into a nucleus of heavier mass, as of helium, with a resultant loss in the combined mass, which is converted into energy. Hot fusion (e.g., fusion at elevated temperatures) has been under intense investigation since the 1940s. Comparatively, cold fusion (e.g., fusion at room temperatures) has received little attention until recently. In an isolated and unsubstantiated laboratory experiment, cold fusion showed there is a slim possibility that it could be developed through relatively simple means at room temperature. B. Stanley Pons & Martin Fleishmann, University of Utah (Mar. 23, 1989). However, experimental efforts to achieve such fusion have not been sustained. In fact, there is much doubt in the scientific community that this form of fusion can be sustained and be useful as a stand-along source of energy. I Amato, Cold Fusion: Wanted Dead and Alive, SCIENCE NEWS, vol. 137, (Apr. 7, 1990); Cold Fusion Saga Trials and Tribulations, SCIENCE NEWS (Jun. 16, 1990).

Nonetheless, development of both forms of fusion is pressing forward. There is little evidence, however, that indicates fusion will be a viable method of generating energy to solve either U.S. or worldwide fuel problems for at least 40 years. Accordingly, there is a continuing need to explore new sources of energy generation to meet global needs.

### SUMMARY OF INVENTION

The present invention provides a portable nuclear-powered plant assembly including a nuclear core, and one or more confinement sections confining the nuclear core. The assembly further includes a fuel source including thorium/uranium-233, positioned in the nuclear core, to create a nuclear reaction. In another embodiment, the nuclear-powered plant assembly further includes a tank arrangement containing a material suitable for thermalization of neutrons.

In another specific configuration, a nuclear-powered plant assembly is provided including a nuclear core defining a plurality of fuel wells spaced-apart about the core, each the fuel well adapted for receipt of a nuclear fuel assembly. At least one primary fuel well is included with a neutron barrier enabling the passage of fast neutrons into the respective fuel well, while preventing the passage thermal (below 1-MeV) neutrons therethrough.

In another aspect of the present invention, a directional neutron source apparatus is provided for a modulating neutrons toward a center core of a nuclear reactor. The source apparatus includes a source assembly including a body containing a neutron source material, and a shield device adjacent the body, configured to substantially prevent the passage of neutrons on one side of the body. A modulator is adapted to selectively modulate the neutrons emitted from the neutron source toward the center core.

In still another configuration, a fuel assembly for a nuclear reactor is provided including a retrievable fuel source containing a fissile material including a homogeneous mixture of thorium and glass. The homogeneous mixture includes about 50% SiO₂, about 47% ²³²ThO₂, and about 3% ²³³UO₂.

In yet another embodiment, a heat transfer assembly for a nuclear reactor, having a heat source, is provided having a heat extraction assembly including a plurality of tubes placed around the heat source in a manner extracting heat from the heat source. The heat extraction assembly is configured to protect a neutron source of the nuclear reactor from reaching an excess temperature.

Another specific embodiment includes a metal enclosure assembly for a nuclear reactor including a metal enclosure defining an interior cavity formed and dimensioned for receipt of the nuclear reactor therein. A primary shielding material substantially surrounds the nuclear reactor that substantially absorbs neutrons emitted from the nuclear reactor.

Still another configuration includes fuel array assembly for a nuclear reactor, having a reactor core, that comprises a plurality of fuel assemblies spaced apart about the reactor core. A primary fuel assembly is contained within a neutron-absorbing drum that is adapted enable the passage of fast neutrons. A modulated neutron source of neutrons is included, wherein the primary the modulated neutron source and neutron-absorbing drum are disposed proximate a center of the fuel array.

In another aspect of the present invention, a fuel element composition is provided for a nuclear reactor including about 50% SiO₂; about 47% ²³²ThO₂; and about 3% ²³³UO₂. The composition is pre-baked at about 2200° F. for about 10 minutes, and wherein the baking (melting) time is a function of the fuel element thickness.

Another embodiment provides a method of fueling a nuclear reactor containing a plurality of wells each configured for receipt of a nuclear fuel assembly, and contained in a thermal neutron region thereof. The method includes positioning a first fuel assembly, having a charge, in a primary well of the reactor; and irradiating the first fuel assembly in the primary well with neutrons from a neutron source for the production of vast fissile uranium-233.

When the charge of the first fuel assembly declines, switching the first fuel assembly from the primary well to a first empty well; and placing a second fuel assembly in the primary well. These events are repeated until the fuel in each fuel assembly is substantially exhausted, removing weapons grade material from the waste stream.

### BRIEF DESCRIPTION OF THE DRAWINGS

The assembly of the present invention has other objects and features of advantage which will be more readily apparent from the following description of the best mode of carrying out the invention and the appended claims, when taken in conjunction with the accompanying drawing, in which:

FIG. 1 is a top perspective view of a Tray Reactor (TR) Inner Core of the Nuclear Reactor constructed in accordance with the present invention.

FIG. 2A is an exploded top perspective view of the Carbon Reflectors of a Neutron Thermalization Assembly of the TR Inner Core of FIG. 1.

FIG. 2B is an enlarged, exploded top perspective view of a Inconnel Graphite Tank Segment of the Neutron Thermalization Assembly.

FIG. 3 is an exploded top perspective view of a Retrievable Fuel Assembly of the Tray Reactor of FIG. 1.

FIG. 4 is an enlarged, exploded top perspective view of a Fuel Element of the Retrievable Fuel Assembly of FIG. 3.

FIG. 4A is an enlarged, front plan view of a Fuel Disk of the Fuel Element of FIG. 4.

FIG. 5 is an enlarged top perspective view of a Heat Transfer Assembly Fuel Element of the Nuclear Reactor of FIG. 1.

FIG. 6 is an exploded top perspective view of a Neutron Source Shielding and Cooling Assembly of the TR Inner Core of FIG. 1.

FIG. 7 is an exploded top perspective view of a Neutron Source Assembly and Modulation System of the TR Inner Core of FIG. 1.

FIG. 8 is an enlarged top perspective view of an External Neutron Source Assembly of the TR Inner Core of FIG. 7.

FIG. 9 is an enlarged, fragmentary, exploded, top perspective view of an alternative embodiment External Neutron Source Assembly originating from a Linear Accelerator (LINAC).

FIG. 9A is an enlarged, side elevation view of the an alternative embodiment External Neutron Source Assembly of FIG. 9, illustrating a Proton Path from a Proton Source from the LINAC.

FIG. 10 is a top perspective view, partial cut-away, of an Enclosure and Primary Shielding of the TR Inner Core of FIG. 1.

FIG. 11 is a fragmentary top perspective view of the Enclosure and Primary Shielding and the TR Inner Core of FIG. 1, demonstrating it portability.

FIG. 12 is a top perspective view, partial cut-away, of the Retrievable Fuel Assemblies and Modulation assembly of the TR Inner Core of FIG. 1, illustrating a Neutron Emitting Drum.

FIG. 13A is a schematic diagram illustrating the Decay Process for Thorium-232.

FIG. 13B is a schematic diagram illustrating the Decay Process for Uranium-238.

FIGS. 14A and 14B are graphs comparing the Fissile Nuclide eta Values.

FIG. 15 is a schematic diagram and visualization of a Control System for a portable nuclear reactor of the present invention.

FIG. 16 is a schematic diagram illustrating a coupling of the portable nuclear reactor of FIG. 15 functioning as a Booster Assembly to a Conventional Nuclear Power Plant.

FIG. 17 is a top perspective view of the Booster Assembly of FIG. 16.

### DETAILED DESCRIPTION OF THE INVENTION

While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims. It will be noted here that for a better understanding, like components are designated by like reference numerals throughout the various figures.

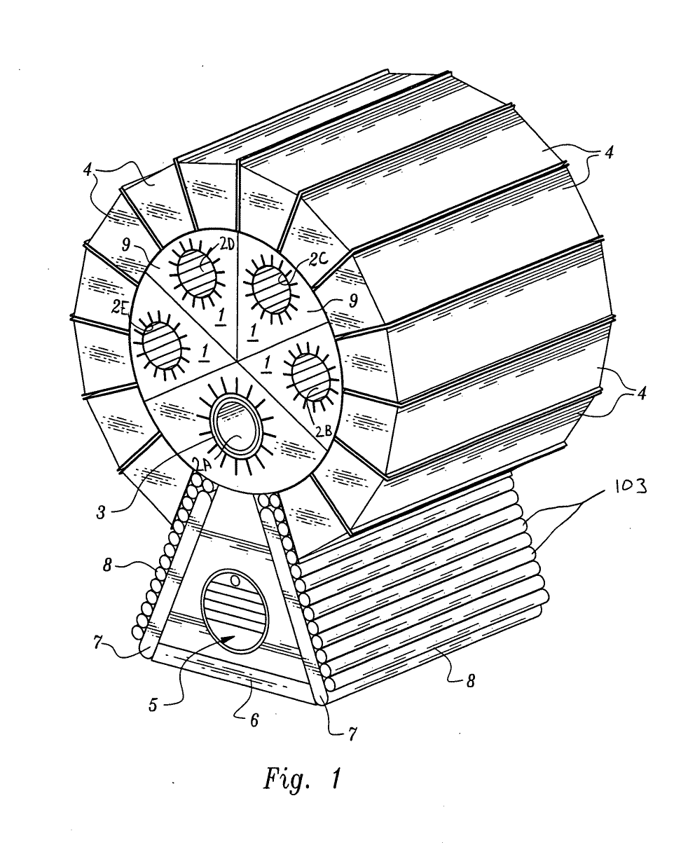

Referring to FIGS. 1-8, a portable nuclear-powered plant assembly including a nuclear core, and one or more confinement sections confining the nuclear core. The assembly further includes a fuel source including thorium/uranium-233, positioned in the nuclear core, to create a nuclear reaction. In another embodiment, the nuclear-powered plant assembly further includes a tank arrangement containing a material suitable for thermalization of neutrons.

The backbone of the process and apparatus of the present invention is hydrogen production via thorium, as a bridge from oil to fusion, while simultaneously reducing the volume of fuel loading and unburned fuel content using a new geometry for nuclear reactors. The production of vitrified solid waste with practically no useable uranium-233 present is one of the primary goals.

Thorium has been used in blankets in several reactors around the world. These blankets are basically a means to capture free neutrons wandering in the reactor vessel, at a neutron flux of 10¹⁴, to produce fissile material. What normally comes out of the blanket is uranium-233 that can be used to enrich low-grade plutonium, thereby increasing the life span of uranium-238. To the best of our knowledge, there has been only one reactor—in India—that was intended to be built using thorium as a main source of fertile material. The proposal assumed that at that time that the government would have reprocessing available to remove the useable uranium-233 from the waste stream.

Historically, neither thorium oxide nor thorium metal has been part of the fuel loading of any conventional reactor built or operating in the U.S., by itself. Substantial studies and proposals have been performed in this country. None of them have been carried forward, basically because the burnout rate of the thorium in conventional reactors is no different than that of plutonium, which calls for a large reprocessing plant not available in the U.S. Without the reprocessing plant, the unburned uranium-233, with its high gamma emissions, must become part of the waste stream. In this case, the Yucca Mountain storage facility would be filled in a few short years, monitoring and storing a monumental waste volume for thousands of years. The U.S. presently does not have means of reprocessing fuel, with the exception of some enrichment facilities for the defense mechanism.

In accordance with the present invention, a means has been developed to package thorium oxide and glass and “pre-bake” tablets that contain 50% SiO₂, 47% ²³²ThO₂, 3% ²³³UO₂ in some configurations. The configuration or technique of switching the fuel assemblies (as will be discussed) from well to well permits the fuel to remain in the reactor until maximum burn is obtained. It is believed that a 90% burn or better can be achieved during advanced development. One of the geometric designs is contained in this application.

Referring now to FIGS. 1-7, the reactor/fuel design of the present invention is a novel approach to using thorium, an element found throughout the world in the mineral monazite, including several large deposits in the United States (U.S.). According to the Encyclopedia of Science, currently known thorium deposits contain more energy than all of the world's uranium and petroleum deposits combined. The initial thorium reactor system of the present invention has a power rating of up to five (5) megawatts (MWs). However, it is believed that this design can be used for systems of 100 MWs or more. The thorium fuel design can also be used economically as an energy source for systems of less than 1 MW. When compared to conventional uranium-based nuclear reactors, the thorium design concept of the present invention totally eliminates the problems of: (a) proliferation of nuclear weapons material; (b) system complexity, (c) vandalism; (d) reactor stability; and (e) the detrimental effects of meltdown. Additionally, when compared to conventional uranium-based nuclear reactors, this thorium design concept drastically reduces the problems of: (a) local environmental impact; (b) waste management; (c) operating costs; and (d) reactor shutdown.

A significant amount of effort has been spent developing a means of extracting hydrogen from water, via nuclear power. These efforts have led to the development of the thorium-based nuclear reactor, which it is believed is a commercially viable product. This reactor is a nuclear energy source that takes advantage of inherent neutron economies, and will generate heat from controlled nuclear activity that takes place in a tray type of fuel confinement. In a shutdown mode, the fuel is solid matter, providing an impervious, tamper-proof container for the spent fuel. This design is thereby fundamentally dissimilar to the conventional nuclear—and other—reactor core designs, which must prevent meltdown by direct forced cooling of the core fuel elements to slow the reaction process. Furthermore, this new reactor system does not depend on primary liquid coolant loops directly in contact with the fuel bundle, nor any of the equipment normally used to extract the thermal energy from the neutron activity. Heat is extracted from this system without direct contact between the coolant and the fuel system.

As previously stated, the reactor of the present invention can be designed in a variety of power sizes, ranging from 1 MW to more than 100 MWs. One of the most important design features of the reactor is that it is very compact, and its design allows the reactor to be used as mobile source of generating energy. It may be used in any application which uses a heat source to generate steam for a thermodynamic cycle (such as driving turbines) to generate electricity or pump water, or to generate hydrogen. The hydrogen generated can be used for many purposes, including fuel for rockets and creating alternative hydrocarbon fuels that can be substituted for petroleum-based fuels.

In order to generate 1 megawatt-day [MW-d] of heat energy, 3.3×10¹⁰ [fissions/s] is needed, or about 1 gram of ²³²Th/²³³U to burn up (1.15741×10⁻⁵ grams of thorium per second). Most of this energy is dissipated as heat within the reactor, thereby obtaining over 90% burnout, drastically increasing the energy efficiency to more than 90% and reducing the amount of waste generated by more than 80%. Traditionally, the amount of neutrons needed for breeding is approximately 10¹⁴ n/cm₂.

After thermalization of fast fission neutrons in the reactor's graphite moderator, ²³³U is produced in the chain reaction following thermal neutron capture in ²³²Th. Although fast neutron capture in ²³²Th resonances is also possible, the ratio of resonance to thermal absorption is 0.13. Nuclear reactions under thermal irradiation of ²³²U are available. The amount of isotopes produced depends on the neutron flux as well as the time of irradiation. For example, three (3) grams of ²³³U will be produced per kilogram of ²³²Th after 20 days of ²³²Th irradiation with a neutron flux in the range of 10¹⁴ n/cm₂.

Representative Distribution of Fission Energy

| | Fission | Heat | |
|---|---|---|---|
| Energy Source | Energy (MeV) | Produced (MeV) | % of Total |
| Fission fragments | 168 | 168 | 84 |
| Neutrons | 5 | 5 | 2.5 |
| Prompt gamma rays | 7 | 7 | 3.5 |
| Delayed radiations | | | |
| Beta particles* | 20 | 8 | 4 |
| Gamma rays | 7 | 7 | 3.5 |
| Radioactive capture | | 5 | 2.5 |
| gammas** | | | |
| Total | 207 | 200 | 100 |

*Includes energy carried by beta particles and antineutrinos; the latter do not reduce heat in reactor systems.
**Nonfission capture reactions contribute heat energy in all real systems: design-specific considerations may change this number by about a factor of two in either direction.

The reaction is obtained during neutron injection (modulated) from two sources: Californium or an accelerator. When the accelerator pulse is on, heat will rise accordingly. In an optimal design the pile will go below K=1 when the accelerator pulse is off. The on/off intervals should maintain:
An average core temperature of about 1,800° F. if a Rankine cycle is used, and a corresponding to about 406° F. saturated temperature is chosen, the heat transfer temperature of about 900° F. will produce superheated steam at about 700° F.

Uranium-233 is made by neutron bombardment of thorium. ²³³U has the smallest fission cross-section and the second lowest v, yet has the largest n and thus the best prospect for breeding.

Racquetball Effect of Neutron Confinement Reflected in Energy conservation, Neutron Conservation, and to an Extent Feedback Effect

For a given output, the multiplication factor and reactivity depends on the size and composition of the reactor. Changing the size or composition, the reactivity can be changed to control the reactor. However, the increase in reactivity consequently increases the temperature. The increase of temperature will decrease reactivity. This is one example of feedback effects on reactivity that the reactor neutron confinement of the present invention enhances.

Computation Observation

The first calculation techniques performed were based on highly-simplified modes. As digital computer technology has developed, more sophisticated models were successively produced that led to the design of the reactor of the present invention. One of the configurations is herein presented. It was determined early on that the neutron population of any chain reacting system is difficult to model because it is characterized by a wide range of energies and directions. Currently, additional calculations will provide sufficient data to construct a demonstration plant of 2 MW output.

In the present invention, continuous removal of xenon buildup is performed by the injection of helium or other suitable element. The presence of xenon is controlled by the core temperature, and it is believed that a fuel burn up of over 90% can be achieved.

Under this scenario the disposal of the fuel will consist of about thirty-six (36) months of monitoring, where the fuel is submersed in water. Later, an unmonitored waste depository site will be developed that is greatly reduced in size. The concept embraces the possibility to do away with high-level waste depositories altogether.

In accordance with the present invention, the reactor 100 is modular high-temperature gas or water-cooled. Applying a multiple cavity fuel element system (i.e., fuel wells 2A-2E) and fuel (fuel assemblies 12) in the form of “raw” thorium embedded in glass pre-baked pellets, and with a single-phase helium coolant, a graphite moderator 9A, and carbon reflectors 4, over 80% of fuel burnout can be achieved. The pellets at disposal time, provide:
1. no potential weapon material
2. about 80% of reduction in waste volume

The reactor design presented herein has been developed for the production of hydrogen using thorium as the energy source. The current configuration developed provides maximum safety for startup, operation, and nuclear waste disposal. The in situ vitrification is for safe waste disposal, and the novel means of neutron sources include, but are not limited to, a Linear Accelerator (LINAC).

The design will include the integration of high-tech innovation for the promotion of safety in connection with fueling startup, operation, shutdown, refining, and waste disposal. The current configuration disclosed meets all of the design performance requirements of simplicity, safety, reactor lifetime, reactor power output control, and economy of low investment and operational cost. Vitrification of the nuclear waste material permits safe shutdown and storage. This feature of the reactor of the present invention addresses a key safety deficiency in current reactor design. The geometric configuration provided herein demonstrates reactor stability.

The technology required for the startup and control of the reactor of the present invention is state-of-the-art. The source of neutrons, and the neutron multiplication design, make possible the operation of a nuclear system of subcritical design by supplying the neutron flux required to bring the system up to a k=0.98 status in a safe and controllable manner when a LINAC is used. The accelerator-developed neutron flux can be instantly stopped, controllably altered to new flux levels, or run at any neutron flux level needed, until the reactor develops its own ability through fuel breeding accelerator power level. The amount of breeding determines the neutron output flux level, and thereby the source can be slaved to the reactor power level to maintain the exact power level desired, without fear of major core excursions. It is necessary here to appreciate the novelty of this unique reactor operation concept.

Thorium, the Fuel

Natural occurrence. Monazite, the most common and commercially most important thorium-bearing mineral, is widely distributed in nature. Important deposits occur along the shores of India, Brazil, and Ceylon. Other extensive deposits of monazite are found in South Africa, the Soviet Union, Scandinavia, and Australia. Sources in the United States include deposits in Florida, Idaho, and the Carolinas. Monazite is chiefly obtained as a sand, which is separated from other sands by physical or mechanical means, following dredging operations. The monazite sand concentrate is essentially an orthophosphate of rare-earth elements, and generally contains 3-10% ThO₂. Other thorium-bearing minerals of lesser importance include thorite, thorianite, and uranothorite.

Metallurgical extraction. Processes for thorium recovery generally start by digestion of the monazite sand with either hot concentrated sulfuric acid or a hot concentrated caustic. Subsequent chemical treatments, varying greatly even with the same initial treatment, yield a concentrate of impure thorium. This impure concentrate may be further treated by a liquid-liquid extraction process to yield high-purity thorium. For a system consisting of water, tributyl phosphate, nitric acid, thorium, and the associated impurities, an extractor can be set up to remove the thorium with the water-immiscible tributyl phosphate phase, where the impurities are carried away in the aqueous phase. Generally, the purified thorium is extracted to an aqueous solution, and either crystallized from solution as the nitrate or precipitated as the oxalate. From these pure salts, the oxide or other compounds of thorium can be prepared.

Because thorium is quite reactive, some difficulty is experienced in preparing thorium metal. Only by electrolysis or by treatment with elements high in the electromotive force series (the alkali and alkaline earth metals) has good-quality thorium metal been satisfactorily prepared directly from its compounds.

The calcium reduction of ThO₂ has been widely used for many years to prepare thorium metal. In this process, granular calcium metal is mixed with thorium oxide and charged into a lined iron crucible, which is then filled with an inert gas and heated to almost 1000° C. (1830° F.) to form thorium metal powder and calcium oxide. After cooling to room temperature, the thorium powder is recovered by leaching and then drying. Powder metallurgy techniques are employed to obtain massive metal.

The electro-deposition of thorium from a bath, consisting of thorium chlorides or fluorides dissolved in fused alkali halides, yields granular thorium which may be pressed and sintered to give massive pieces of ductile metal.

Thorium can be converted in a nuclear reactor to uranium-233. The system of thorium and uranium-233 gives promise of complete utilization of all thorium in the production of atomic power.

Referring now to FIGS. 1-7, the Nuclear Reactor assembly 100 of the present invention will now be described in detail. As viewed in FIG. 1, four semi-cylindrical (pie-shaped) Graphite Tanks Segments 1, and a primary segment 1A collectively form an inner core of the reactor 100. Each segment defines an empty fuel well 2A-2E. The purpose of the inner core is to provide a cradle for a nuclear reaction and an empty well to add and switch fuel during the lifespan of the reactor. The tank construction 9 is the same with some dimension differences.

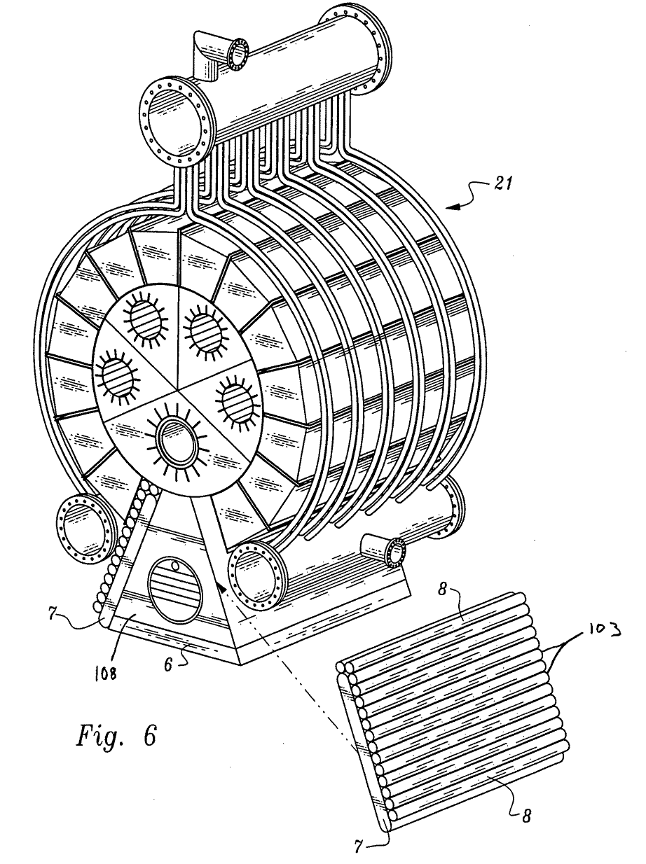

Each fuel well 2A-2E provides a cavity that receives and supports the reactor fuel charge (contained in fuel assemblies 12). These charges are designed by computerization of fuel reactivity at a given time. The charges are the source of heat energy that flows outward toward the heat exchanger assembly 21 situated in the outer perimeter of the collective assembly of the carbon reflectors 4 (FIG. 6).

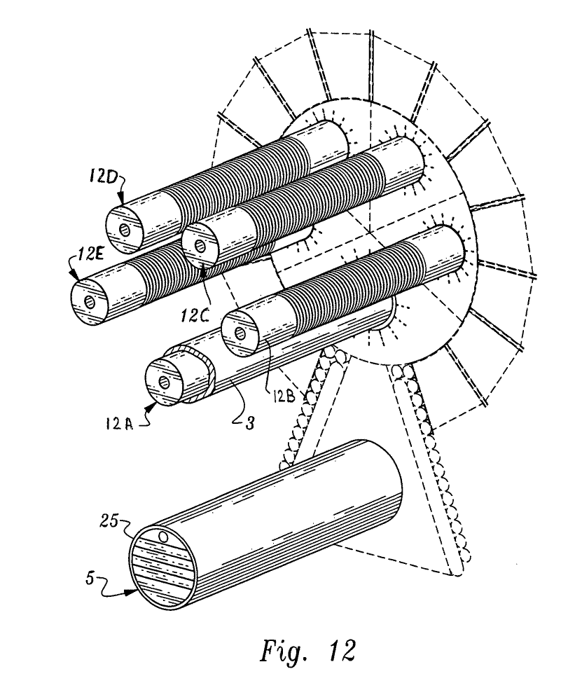

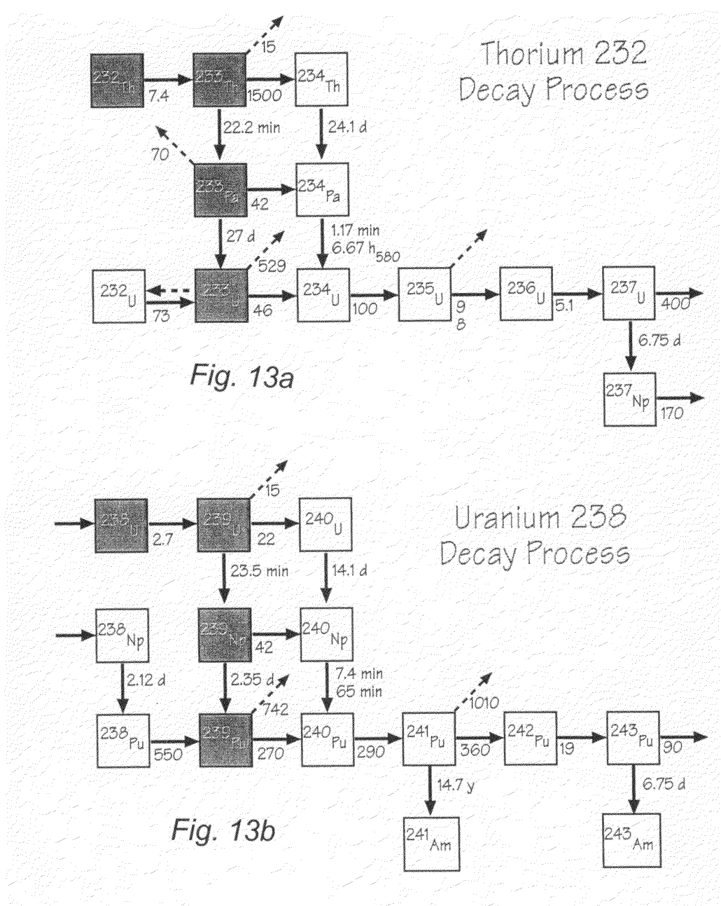

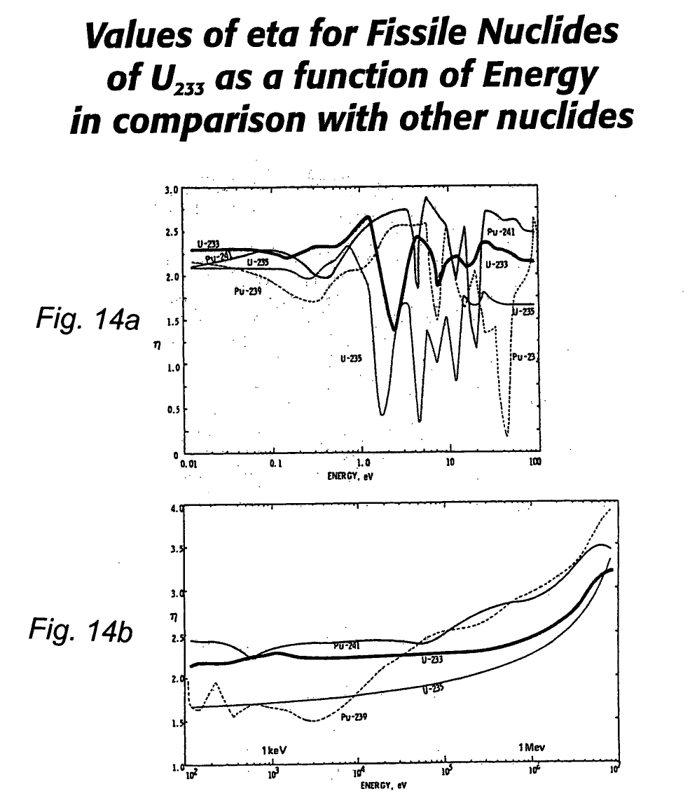

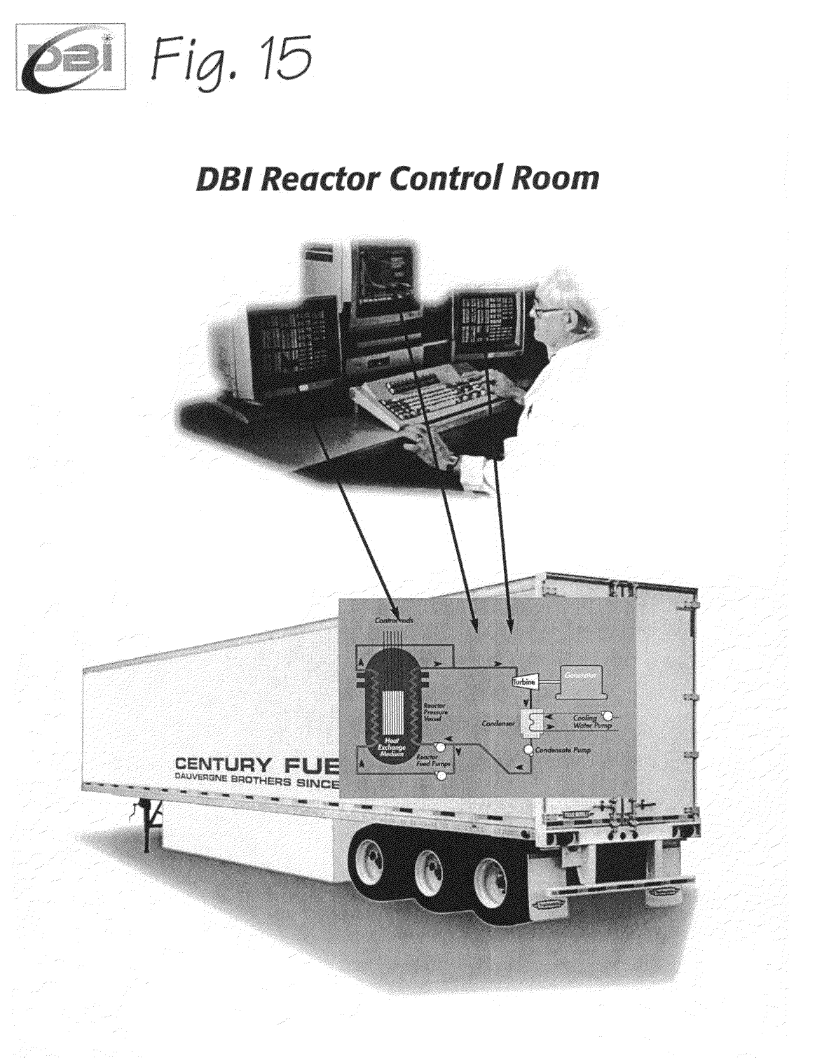

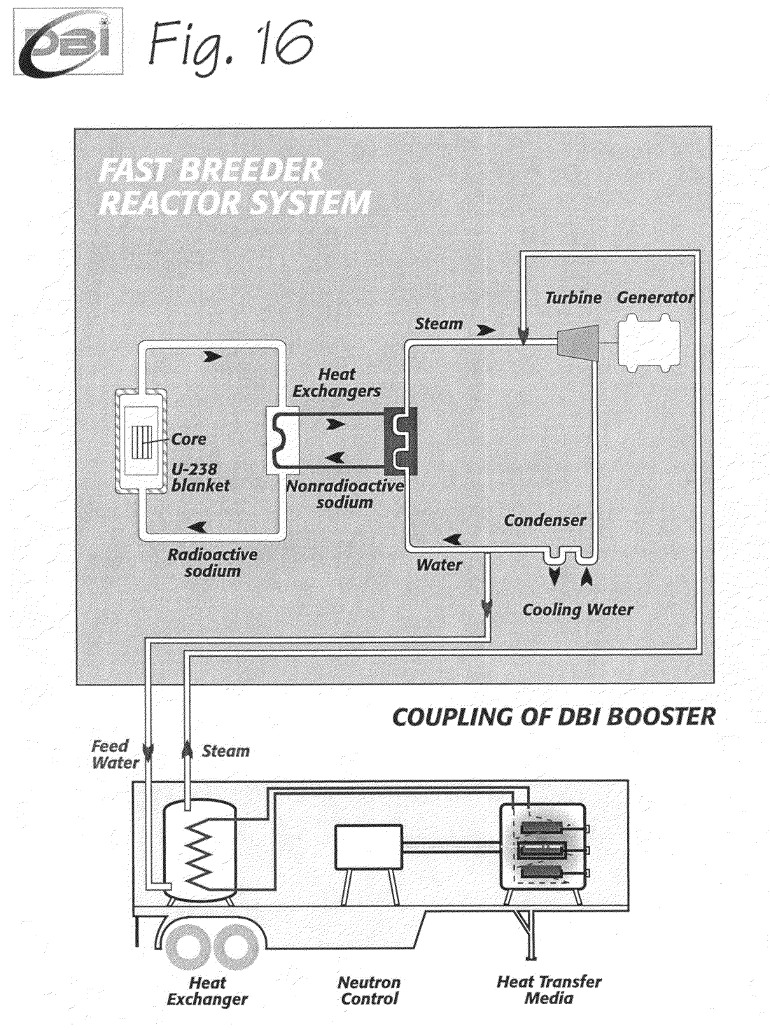

As best viewed in FIGS. 1 and 12, the primary fuel well 2A includes a cylindrical-shaped barrier 3 that allows only fast neutrons to penetrate. The concept here is to hold thermal neutrons previously thermalized in the graphite tank segments 1, and be able to capture and maintain them, to be absorbed by the fertile material (Th/²³²U, later converted into fissile material in the form of ²³³U) that the machine uses for fuel.

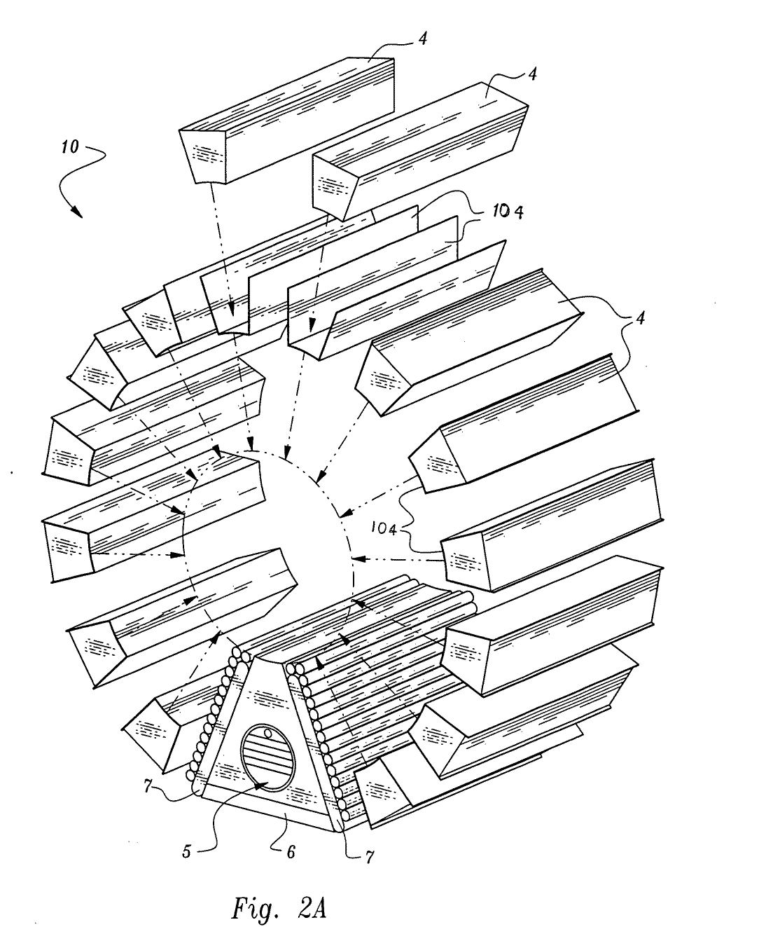

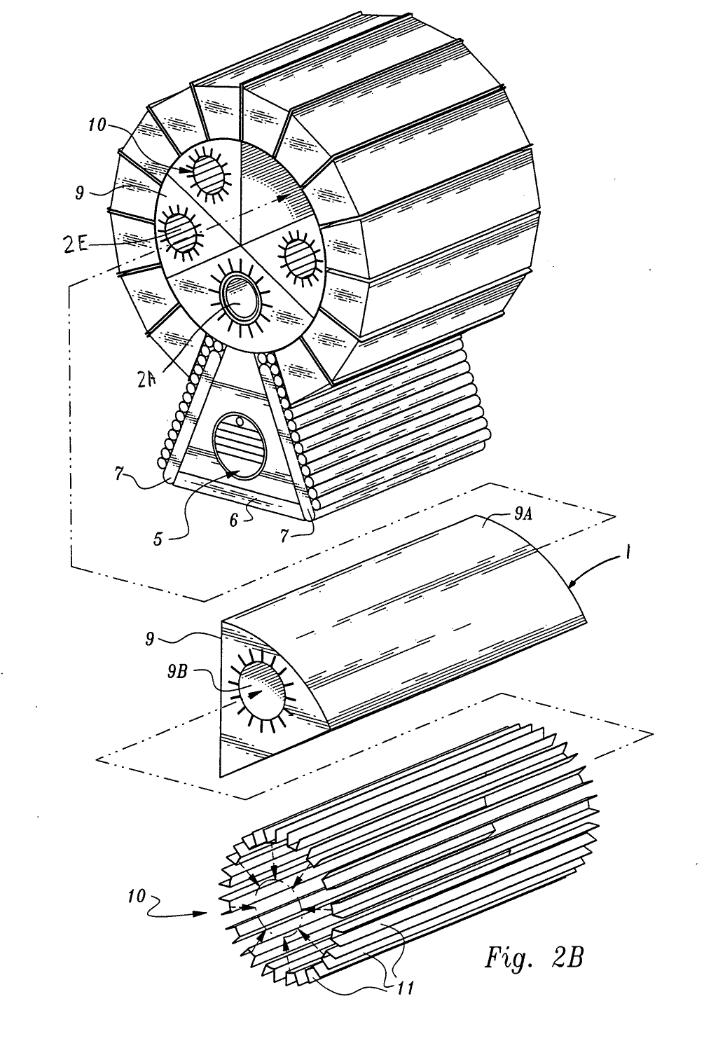

A plurality of Carbon Reflectors 4 (FIG. 2) are disposed around the periphery of the assembled inner core of graphite segments 1. These reflectors 4 are multiple segments that create a confinement for fast neutrons to bounce back to the inner core, thus allowing fast neutrons to lose energy within the reactor assembly instead of being lost within the reactor walls.

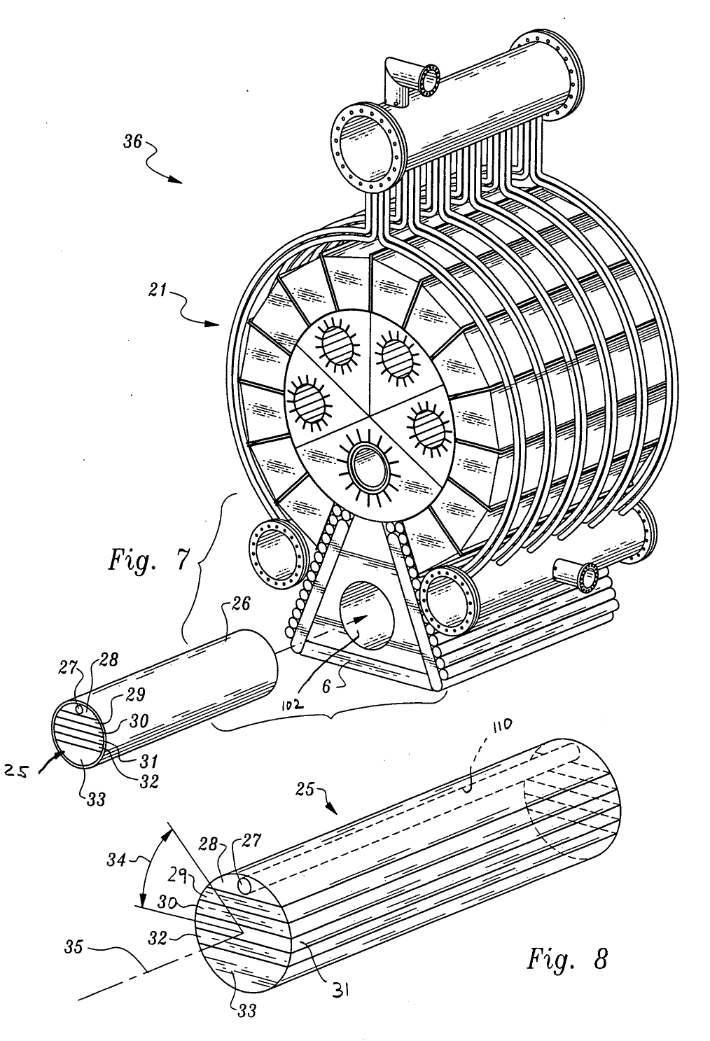

FIGS. 1 and 7 illustrate a Reactor External Neutron Source Modulation Assembly 5 that is inserted into source well 102. This assembly 5 allows the reactor to operate below k=1 (subcritical, at about 0.995) and provide neutrons to the immediately-adjacent fuel well 2A. In one embodiment of FIG. 8, the neutrons are modulated by rotating the inner drum 26 about axis 35, where if the source of neutrons, as will be mentioned, is facing the wall of lower absorber 6, the reactor will shut off.

The Lower Absorber 6 allows the external source of neutrons (element 27 as will be described) to be absorbed and is responsible for the shutting off of the reactor. Collectively, side Absorbers/Shielding (one on each side) 7 provide additional shielding that absorbs neutrons from the external neutron source 27. This further assures the ability to modulate and shut down the reactor when the neutron source 27 rotates to a specific position in inner drum 26

Positioned atop the outer surface of the side absorbers 7 is a Heat Transfer Media 8. These are preferably provided by a plurality of elongated rods 103, and convert the radiation heat from the side absorbers 7 into a useable source of energy and maintains mechanical stability in the immediate region.

Referring now to FIG. 2B, each graphite tank segment 1 includes an Inconnel Tank 9 that encapsulates a graphite segment 9A therein. These tanks 9 are provided to prevent any air from penetrating the granulated carbon of the graphite segments 1, thus avoiding the combustion of the carbon since the immediate area is exposed to about 1700° F.

Each tank 9 or graphite segment 9A defines a segment well 9B, respectively. A plurality of inconnel U-Channels 11 surround the walls of the segment well 9B (FIG. 2B) to collectively form the respective fuel wells 2A-2E. These inconnel U-Channels 11 prevent the fueling and refueling friction to upset the graphite content of the tank 9 during insertion and removal of the retrievable fuel assemblies 12 during switching.

As will be described, these fuel wells 2A-2E permit the retrievable fuel assemblies 12 to be switched from well to well, until the fuel is totally burned. Very advanced computer analyses are used to determine the reactivity of the fuel switching and the addition of new fuel whenever switching takes place.

In a similar manner, as shown in FIG. 2A, the carbon reflectors 4 are also insulated from the from the inner core by U-channels 104.

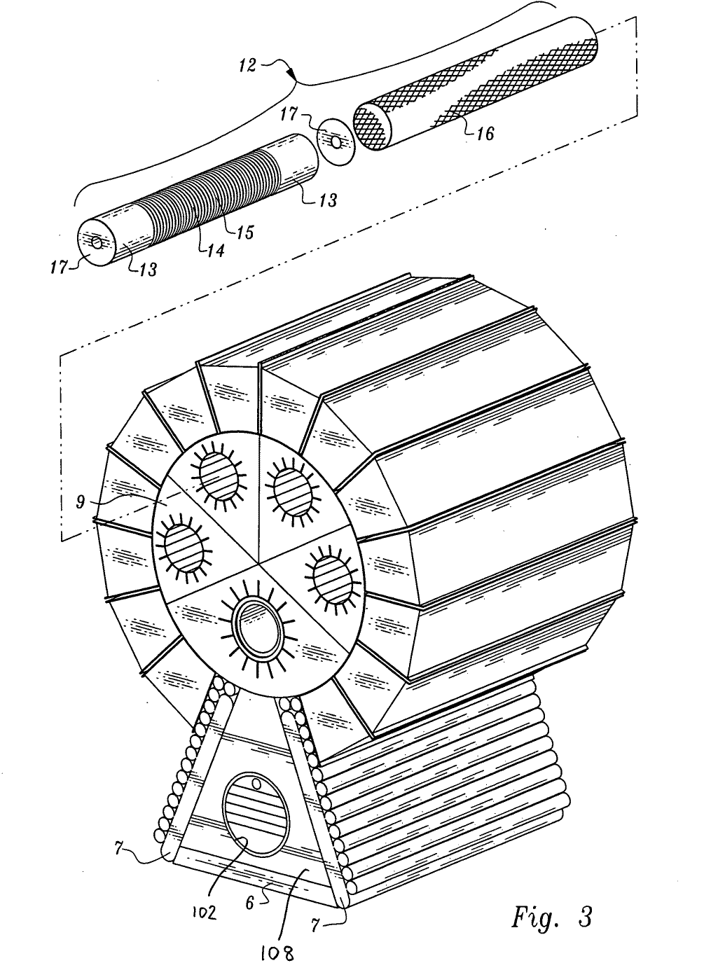

FIG. 3 best illustrates the Retrievable Fuel Assemblies 12 that are computer-calculated to establishes the life of each fuel charge (amount of fuel available). The complete assembly 12 is removable and able to be switched to an empty well 2A-2E when its fuel content has diminished, as will be described. Each fuel assembly 12 includes end piece carbon inserts 13 that sandwich a plurality of Fuel Disks 14 and Poison Disks 15 therebetween. These carbon insert 13 provides partial thermalization of neutrons within the fuel assembly 12. The fuel disks 14 are a mixture of fertile material, glass, and a small amount of fissile material. Among the fuel disks 14 are these “poison” disks 15 which are necessary to maintain subcriticality (k=0.995).

The assembled fuel and poison disks 14, 15 and the carbon inserts 13 are positioned in a Fuel Assembly Sleeve 16, In one configuration, the sleeve 16 composed of expanded steel and resembles chicken wire. This permits thermal expansion by the fuel assembly 12 throughout the lifetime of the fuel. A pair of Fuel Assembly End Caps 17 are positioned at the opposed ends of the carbon inserts 13 (FIG. 4). These caps 17 are welded to the end of the fuel assembly sleeve 16 to prevent the fuel from spilling from the sleeve.

As best illustrated in FIG. 4, Fuel Disk Separators 18 separate each fuel disk 14 and poison disks 15. That is, each fuel disk 14 with a charge on it is separated from the other disks, thus allowing xenon to be bled on a continuous basis. Xenon is an undesired neutron absorber responsible for contaminating the fuel. Its continuous removal helps prevent fuel contamination.

A Fuel Disk Center Cavity 19 extends through each end cap 17, carbon insert 13, fuel disk 14, poison disk 15, and separator 18. This center cavity 19 allows for the flow of helium (or similar gas) therethrough to remove the xenon on a continuous basis. Collectively, the center cavities 19 form an elongated channel or Xenon Removal Path 20 through the fuel assembly 12 that creates a free path for the helium (or similar gas) to carry away the xenon.

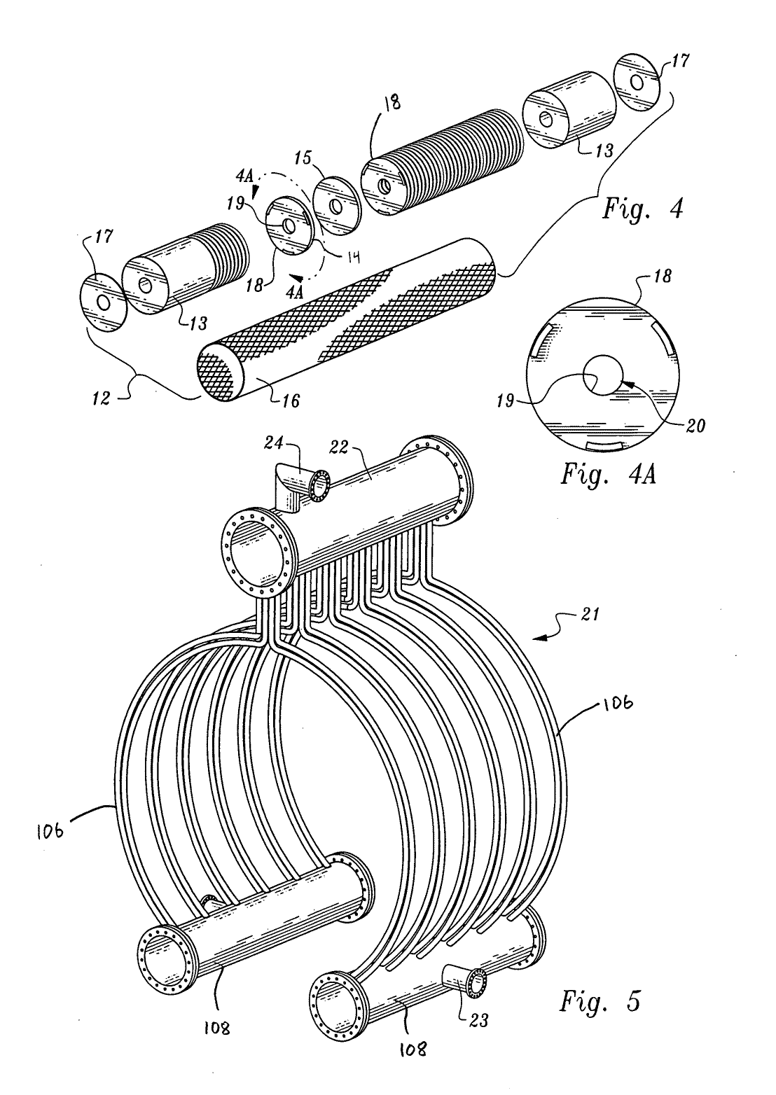

Turning now to FIGS. 5 and 6, the Primary Heat Transfer Assembly 21 is shown. This heat transfer assembly 21 is basically an ASME-stamped heat exchanger that receives the heat from the reaction through convection. A plurality of heat transfer tubes 106 are built within ASME specifications and are imbedded in a heat transfer media (not shown, but is a mixture of carbon and copper, or carbon and aluminum). The presence of copper and aluminum is to increase the thermal conductivity of the tubes' surface area.

The heat transfer tubes 106 are coupled to a Three-Drum Assembly 22, as per ASME regulations. At the bottom are entrance drums 108 which are coupled to the entrance of transfer tubes 106. Each entrance drum 108 includes a Heat Transfer Media Cold Inlet 23 that allows the gas or liquid heat transfer media to enter. The exits of the transfer tubes 106 terminate into an exit drum 22. The heat of the reaction is carried through a Heat Transfer Media Hot Outlet 24 by the transfer media. This heat will be employed in any conventional equipment that converts high temperature gases into mechanical energy (such as turbines). These drums 22, 108, and the connection between the drums and the heat transfer tubes 106 are within conventional ASME guidelines.

Referring now to FIGS. 7 and 8, a Rotating Element 25 is shown that is slideably inserted into and rotatably housed in an inner drum 26, the two of which essentially compose the Reactor External Neutron Source Modulation Assembly 5. In turn, the modulation assembly is inserted into the well 102 of triangular-shaped base 108. The Inner Drum 26 is preferably composed of steel.

The rotating element is composed of a plurality of stacked, plate-shaped absorbers 30-33, and steel plate 29 and steel segment 28. Collectively, these define the cylindrical-shaped rotating element viewed in FIG. 8. The semi-cylindrical shaped steel segment 28 include an elongated cavity 110 that houses an elongated Neutron-Emitting Element 27 therein. This element 27 contains the manmade element Californium, for example. The half-life of Californium also establishes the refueling time of the entire reactor.

The Steel Barrier 29 component functions to slow down the fast neutrons emitted from the source element 27. The stacked plate components 30-32 are Boron/Steel Absorbers that are applied to further absorb neutrons emanating from source element 27. In the bottom of the rotating element 25 is semi-cylindrical shaped Boron/Clay Absorber 33. This absorber is used for total absorption of neutrons.

As shown in FIG. 8, the Modulation Direction represents the angular rotation of the rotating element 25 of up to about 180 degrees. This modulates neutrons emitted from the source element 27 by rotating the rotating element up to 180 degrees about the Modulation Drum Center Axis 35. This center axis represents the point of rotation of the neutron source, and can be driven by a conventional gearbox.

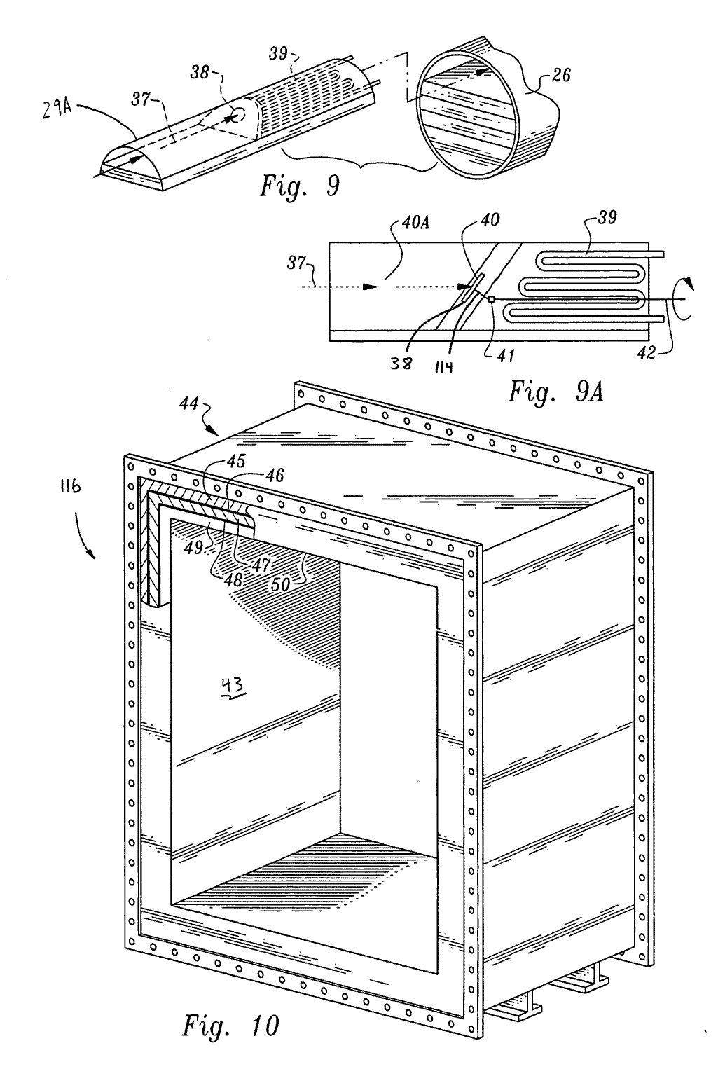

In one specific embodiment of FIGS. 9 and 9A, a Proton Source (e.g., a Linear Accelerator (LINAC)) emits protons traveling along proton path 37. When a linear accelerator is used, the inner drum 26 is stationary, since the modulation of neutrons is obtained by the modulation of protons, that in turn produce the necessary neutrons at the target area. In this configuration, the proton path 37 extends through a vacuum tube device 19A where it strikes a target face 40 of a Beryllium Target 38, creating neutrons. This target 38 rotates about axis 114, thus preventing the protons from striking the same area of the face continuously.

A Target Angle Drive 41 allows the target 38 to be inclined, to create a wide angle of neutron distribution. A Drive Shaft 42 drives the angle drive 41, which in turn is driven by a conventional gearbox operated electrically or mechanically. A Beryllium Target Coolant heat exchanger 39 is positioned behind the target 38 and wall 112 that removes the heat from the mechanical segment of the rotating target mechanism.

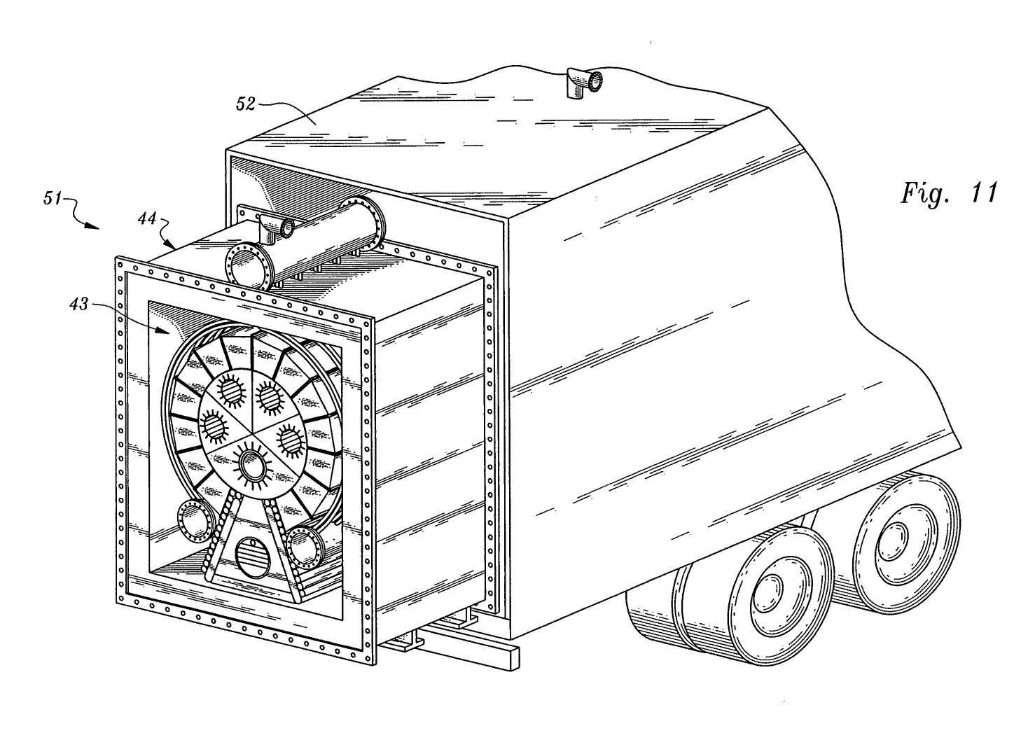

Turning now to FIGS. 10 and 11, a shielded metal enclosure 44 is shown which house the reactor 100 in an Entire Inner Assembly 43. The Metal Enclosure includes a steel metal enclosure that prevents the escape of all alpha and beta emissions, and some gamma emissions. A Near-Surface Temperature Barrier layer 45 is disposed within the metal enclosure, and functions as a temperature insulation barrier that allows the metal enclosure to attain a surface temperature of about 100° F. Adjacent barrier layer 45, as shown in FIG. 10, is Gamma and Neutron shielding (#3) 46 which is a tertiary gamma emission barrier, comprised of about one inch of steel. Another high temperature Temperature Barrier 47 in included that allows radial heat dissipation as the surface area increases in the adjacent outward elements. Again, adjacent temperature barrier 47 is a layer of Gamma and Neutron Shielding (#2) 48. This is a secondary gamma emission barrier that is also comprised of about one inch of steel. Another layer of Gamma and Neutron Shielding (#1) 50 lines the inner assembly 43. This is the primary gamma emission barrier, and is also comprised of one inch of steel. An air gap 49 peripherally separates Temperature barrier 47 from #2 shielding layer 48 from #1 shielding layer 50. This gap is filled with inert gas, thus preventing total contact with the primary shielding.

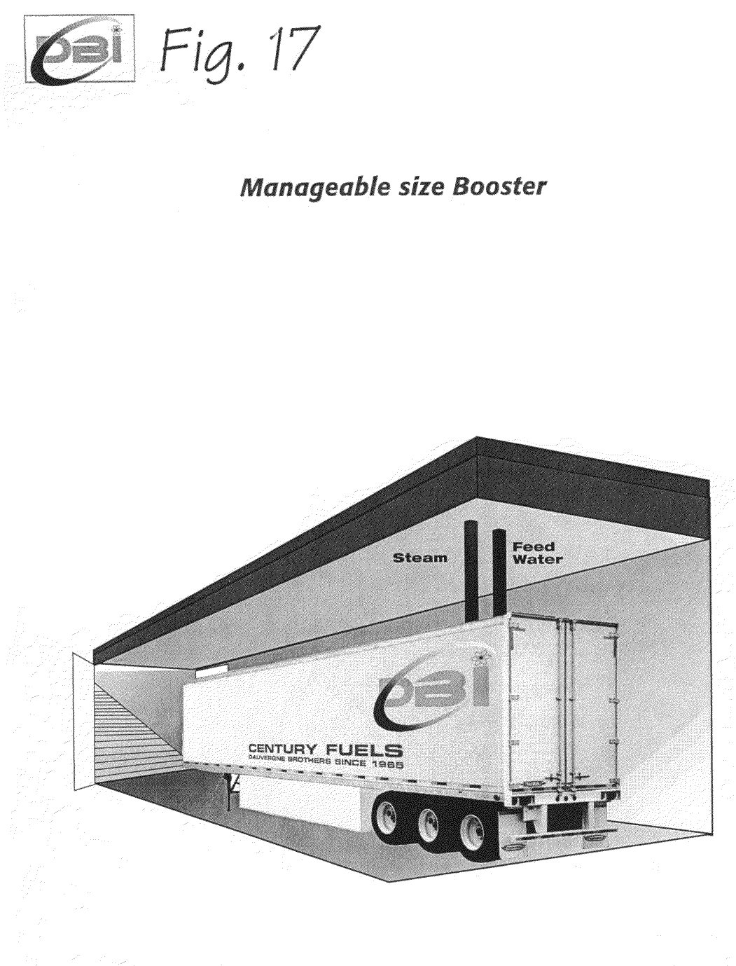

FIG. 11 illustrates a reactor 100 mounted in the entire inner assembly 43 of the enclosure 44. Collectively, this Entire Assembly 51 is mounted to a conventional trailer 52, illustrating it portability. This allows the unit to be mobile and become a steam producer at a host location (pre-existing power plant), such as those examples shown in FIGS. 16 and 17.

The operation of the reactor assembly 100 is as follows. In accordance with the present invention, the reactor operation relies on an external source of neutrons (i.e., either a neutron emitting element 27 or an LINAC) emanating from the external neutron source modulation assembly 5 assembly shown in FIG. 1, and more particularly, in FIGS. 7-9. The neutron source assembly 5 contains a neutron shielding and an absorber material (stacked absorber plates 29-33) on one radial side of the source assembly, and the neutron source (i.e., either a neutron emitting element 27 or the LINAC) on the opposite side thereof. The first set of stacked plates 29-32 are boron/steel absorbers. Regarding the end absorber 33, this is preferably a boron/clay composite.

The neutron source, in one configuration is an elongated neutron-emitting element 27 extending the longitudinal length of the rotating element 25 (FIG. 8). One example of a neutron-emitting element in accordance with the present invention is the element Californium, which has the ability to produce a neutron flux in the range of about 10¹¹ and can be other materials capable of, or can be controlled, to produce a neutron flux in the range of about 10¹¹. In another specific configuration, as shown in FIGS. 9 and 9A, man-made neutrons are driven by a source of protons coming from a linear accelerator (LINAC), also producing a flux of 10¹¹.

In the first described neutron-emitting source 27, the rotating source assembly 25 is rotatably positioned in source well 102 of triangular-shaped base 108, where it rotates about longitudinal axis 35 shown in FIG. 8. Since the plate absorbers 29-33 are only stationed on one side the rotating source assembly 25, the rotating movement provides or deprives neutrons to the retrievable fuel assembly 12 positioned in the primary well 2A illustrated in FIG. 1.

Briefly, the absorber plates 29-33 and semi-cylindrical shaped steel segment 28 collectively form the rotating source assembly 25 which is slideably positioned in inner drum 26. In turn, inner drum 26 is slideably placed in the source well 102 of base 108, as shown in FIG. 7.

In accordance with the present invention, as mentioned, the rotation of the source assembly 25 in inner drum 26 provides or deprives neutrons from the neutron-emitting source 27 to the retrievable fuel assembly 12. By rotating the entire modulation assembly about center axis 35 and between the rotation angle 34 from 0° to about 180°, the reaction can be controlled. A conventional motor and gear box assembly drive the rotation of rotating source assembly 25 about axis 35.

In the second neutron source shown in FIGS. 9 and 9A, the neutrons 37 are provided or deprived by the modulation of the proton source (i.e., LINAC). In either source embodiment, the source of neutrons serves as neutron modulation to the location of fuel wells 2A-2E, as shown in FIG. 12.

The primary fuel well 2A, shown in FIG. 1, is surrounded by a hollow cylindrical cadmium barrier 3. This barrier permits only fast neutrons of about 1 MeV and above to penetrate, but will not permit thermal neutrons (below 1 MeV) to penetrate. The fast neutrons emanating from the fuel well 2A allow the transmutation of thorium-232 through proctanium for the production of vast fissile uranium-233 in situ, as per FIG. 12. The thermal neutron region is continuously receiving fast and thermal neutrons from adjacent fuel charges.

In accordance with the present invention, one key feature of the present invention relates to switching of the fuel assemblies 12A-12E from well to well until the fuel is substantially expended. This allows up to about 80% reduction in the nuclear waste, if and when the system is implemented. For example, during the reactor startup, the four outside wells 2B-2E, shown in FIGS. 1 and 2B, adjacent to the main or primary well 2A, are empty. Referring to FIG. 12 (although only the sequentially last position is shown), suppose a charged fuel assembly 12B was initially placed in primary well 2A. When this fuel assembly begins discharging (declining in power), there is permissible time to switch this fuel assembly 12B to the first empty well 2B, and then place a new charge (fuel assembly 12C) in the primary well 2A.

At the second startup, there will be an excess of power. At this time the modulation of man-made neutrons takes place by either rotating the drum 26 with Californium on it, or modulating the source of protons 37 coming from a LINAC. When the source of man-made neutrons are not enough to support total power, the third startup will occur. At this time, it is necessary to switch the last charge fuel assembly 12C into the second empty well 2C, and replace it with a new charge (fuel assembly 2D) in primary well 2A. There is an excess of power again, at the third startup, which is again controlled by the modulation of the neutron source. When the modulation reaches the maximum, fuel charges are again moved to new wells.

This fuel assembly switch process from the primary well 2A continues until all the original empty wells 2B-2E are filled, as shown in FIG. 12. Once the fifth charge fuel assembly 12E is ready for placement into the original empty well 2E, the first charge fuel assembly 12B positioned in the original first empty well 2B is removed for disposal. At this time, the charge of the first charge fuel assembly 12B will have a potential burnout of over about 90% of the fuel, since a continuous removal of xenon (a byproduct that absorbs otherwise useable neutrons) has taken place.

At the time the first charge fuel assembly 12B is removed, no weapons material is present in the waste stream. Since the composition of the first load of waste is vitrified, the burned out fuel elements are placed in water for 36 months. Once cold, they will contain short-lived isotopes whose half-lives range from 28-29 years (6.80% strontium-90, 7.16% cesium-137), and long-decaying isotopes whose half-lives range from 1.1×10⁶ to 2.6×10⁶ years (7.1% zirconium-93, ≧4.9% cesium-135). These materials, being vitrified in situ, do not need long-term monitoring once out of the pool of water.

Referring now to FIGS. 5-7, the heat generated by the nuclear core 100 is removed by convection between the core 100 and the outer heat transferring tube elements 106 of the primary heat transfer assembly 21 extending around the carbon reflectors 4. This ASME-stamped heat exchanger is conventional. One example of a conventional gaseous heat transfer media flowing through the tubes is helium. The continuous removal of xenon takes place at the fuel charge, shown in FIG. 4, as the helium flows through the path 20, during the tenure at the core.

The shielding of the assembly is conventional. It meets the demand of neutron energies and gamma emissions. What is also conventional is the metallurgy and material selection throughout the core. The power recovery is also conventional, whether the media embraces a gas-to-water heat exchanger to produce super-heated steam, or for the steam to be used directly for the production of hydrogen or in a Rankine Cycle for the production of electricity.

Accordingly, reactor of the present invention is: (a) to drastically reduce the size of the fuel charge in a reactor; (b) to drastically reduce nuclear waste volume; (c) to eliminate weapons material in the waste stream; (d) to eliminate the need for reprocessing of nuclear fuel; (e) to create a possible scenario where, using our type of reactor, all U.S. electrical energy for the next 250 years will come from thorium; and (e) to have the site of 250 years worth of waste disposal equal one-fourth the size of Yucca Mountain.

### In Summary

1) Portability. The system is portable in that it can be confined within the dimensions of a large, over-the-road trailer (8×12×40 feet). Several factors are involved in this requirement, such as the ability to place the system on any location, without sight preparation, any place in the world.
2) Cost of Operation. The end user of this power generation system must be able to operate it at a cost of no more than 1.8 cents/kilowatt-hour. In the years of research, it has concluded that 1.1-1.8 cents/kw-h (1990 dollars) is possible. Over 80% of the equipment in conventional nuclear reactors, and their associated costs, are not required in this reactor. Core meltdown prevention is not a factor in this reactor, since it is inherent by design.
3) Environmental Impact. The fuel, as well as the core and containment vessel, is of such a detailed design that it can be operated without fear of radioactive proliferation or residual nuclear waste disposal problems. In situ vitrification will be used for waste management using a method of 36- to 48-month underwater treatment of vitrified waste.
4) Photoneutron Activation. The system design is to be compatible with the photoneutron gun that is being designed to bombard the thorium with free neutrons to shift the fertile ²³²Th into man-made fissile ²³³U. This design allows the construction of the entire reactor system without special equipment in a benign state, the shipping of the system to its final destination, and the commissioning and decommissioning of it at will.

Although only a few embodiments of the present inventions have been described in detail, it should be understood that the present inventions may be embodied in many other specific forms without departing from the spirit or scope of the inventions.

1-16. (canceled)

17. A method of operating a nuclear reactor comprising:
providing a nuclear fuel assembly comprising thorium-232;
irradiating the nuclear fuel assembly in a first position in the reactor core with neutrons to breed uranium-233;
irradiating the nuclear fuel assembly in one or more other positions in the reactor core with neutrons to fission the uranium-233 until at least twenty-five percent of the thorium-232 and uranium-233 in the fuel assembly is depleted; and
removing the nuclear fuel assembly from the reactor core.

18. The method of claim 17 wherein the nuclear fuel assembly is irradiated with neutrons until at least twenty-five percent of the thorium-232 and uranium-233 in the fuel assembly is depleted.

19. The method of claim 17 wherein xenon that is produced during the irradiation of the nuclear fuel assembly is continuously removed from the reactor core by a flow of gas.

20. The method of claim 17 wherein the nuclear waste material contained in the removed nuclear fuel assembly is vitrified.

21. The method of claim 17 wherein the nuclear fuel assembly contains no weapons material.

22. The method of claim 17 wherein the nuclear fuel in the nuclear fuel assembly comprises about 50% SiO₂, 47% ²³²ThO₂ and 3% ²³³UO₂ prior to being irradiated by neutrons in the first position.

23. A method of fueling a nuclear reactor comprising a plurality of spaced apart fuel wells, each fuel well being configured to removeably receive a nuclear fuel assembly, the fuel assembly comprising a plurality of fuel elements, each of said fuel elements comprising a mixture of fertile thorium-232, fissile material and glass encased in solid and gas permeable glass, wherein uranium-233 is bred by transmutation of thorium-232,
said method comprising:
positioning a first nuclear fuel assembly in a primary fuel well, the primary fuel well being surrounded by a neutron barrier enabling the passage of fast neutrons into the primary fuel well while preventing the passage of thermal neutrons into the primary fuel well;
irradiating the first nuclear fuel assembly in the primary fuel well with neutrons from a neutron source for the production of fissile uranium-233;
removing the first nuclear fuel assembly from the primary fuel well and positioning the first nuclear fuel assembly in a first secondary fuel well wherein the first fuel assembly is irradiated by thermal neutrons;
positioning a second nuclear fuel assembly in a primary fuel well;
irradiating the second nuclear fuel assembly in the primary fuel well with neutrons from a neutron source for the production of fissile uranium-233; and
removing the second nuclear fuel assembly from the primary fuel well and positioning the second nuclear fuel assembly to a second secondary fuel well wherein the second nuclear fuel assembly is irradiated by thermal neutrons.

24. The method of claim 23 further comprising removing the first or second nuclear fuel assembly from a secondary fuel well when more than one percent of the nuclear fuel in the assembly had been depleted.

25. The method of claim 24 wherein the first or second nuclear fuel assembly is removed from a secondary fuel well when more than twenty-five percent of the nuclear fuel in the assembly had been depleted.

26. The method of claim 24 wherein the first or second nuclear fuel assembly contains no weapons material when it is removed from the secondary fuel well.

27. The method of claim 23 wherein the nuclear fuel in the first and second nuclear fuel assemblies comprise about 50% SiO₂, 47% ²³²ThO₂ and 3% ²³³UO₂ prior to being irradiated by neutrons in a primary fuel well.

28. A method of disposing nuclear fuel assemblies following irradiation of the assembly in a nuclear reactor, said method comprising:
removing a nuclear fuel assembly from the nuclear reactor, the assembly comprising vitrified nuclear fuel and fission products; and
immersing the nuclear fuel assembly in water for at least 36 months.
